(19) United States
(12) Patent Application Publication
(10) Pub. No.: US 2021/0059236 A1
(43) Pub. Date: Mar. 4, 2021

(54) Glue Tube

(71) Applicant: Melvin Harold Kohl, JR., St. Charles, MO (US)

(72) Inventor: Melvin Harold Kohl, JR., St. Charles, MO (US)

(21) Appl. No.: 16/554,767

(22) Filed: Aug. 29, 2019

(51) Int. Cl. A01M 23/00

(52) U.S. Cl. CPC A01M 23/005

(57) ABSTRACT

A Glue Tube for trapping moles and other rodents is designed to form its own packaging. In this case, a glue tube package is formed by a sturdy cardboard tube with a non-drying biodegradable adhesive applied to the inner diameter walls. Protective end caps are inserted into each open end to protect the adhesive and the user until time of use. No outer packaging is required. To use, the end caps are removed and, the tube is inserted into an underground tunnel created by a rodent. The tube is inserted underground aligning with the existing path while the adhesive inner surface is exposed for rodents entering or traversing the length of the tube. Complete coverage of the inner lining with glue increases its effectiveness in trapping rodents. Due to its use of biodegradable materials the Glue Tube can be left underground to naturally decompose and break down.

### BACKGROUND OF THE INVENTION

This invention relates to glue traps which use a non-drying very sticky adhesive for trapping insects, vermin and rodents such as moles, voles, rats and mice. Glue traps of this nature are well known in the art and are available in many different forms for different applications.

The present invention requires no assembly and is in the form of a cylinder tube having a pre-applied interior glue layer which is used particularly for trapping moles, voles, rats and other rodents. Thus, in use, the tube is placed, for example, in a mole burrow path or tunnel underground to be entered into through normal traversing activity.

Known glue trays of the above kind are commonly made of a plastic material, filled with the glue and packaged, in multiples, in a chipboard or other box. In use, a consumer must remove the trays from the box, dispose of the box and also of the trays after they have been used. Because the trays are made of plastic, they have a long life cycle in a landfill or dump. Also, the tray design, with its limited glue exposure can make it possible for a rodent or insect to escape with or from.

### SUMMARY OF THE INVENTION

It is a general object of the invention to provide improvements in the manufacture, construction and convenience of tray-type glue traps. Another object of the invention is to provide a glue trap that automatically protects the trap from collapse and dirt and debris due to the cylindrical structure, greatly extending the adhesive life and effectiveness when used underground.

Another object of the invention is the increased coverage area to increase the successful trapping of rodents that come into contact with the inner wall of the tube.

Still another object of the invention is to provide a glue tube for trapping rodents which is entirely biodegradable and not harmful to the environment.

A further object of the invention is to provide a trap that simplifies disposal of rodents after trapping, minimizing exposure to disease and deceased carcass by persons handling the trap.

Additional objects of the invention, along with its features and advantages will become apparent from the ensuing description and claims read in conjunction with the attached drawings.

### BRIEF DESCRIPTION OF DRAWINGS

FIG. 1 is a 3-D perspective view of a cardboard tube with an internal coating indicated for adhesive according to the invention, showing removable endcaps for protecting internal adhesive until needed.

FIG. 2 is an end view of the glue tube indicating coating coverage.

FIG. 3 is a side elevational view of the glue tube.

### DESCRIPTION OF PREFERRED EMBODIMENTS

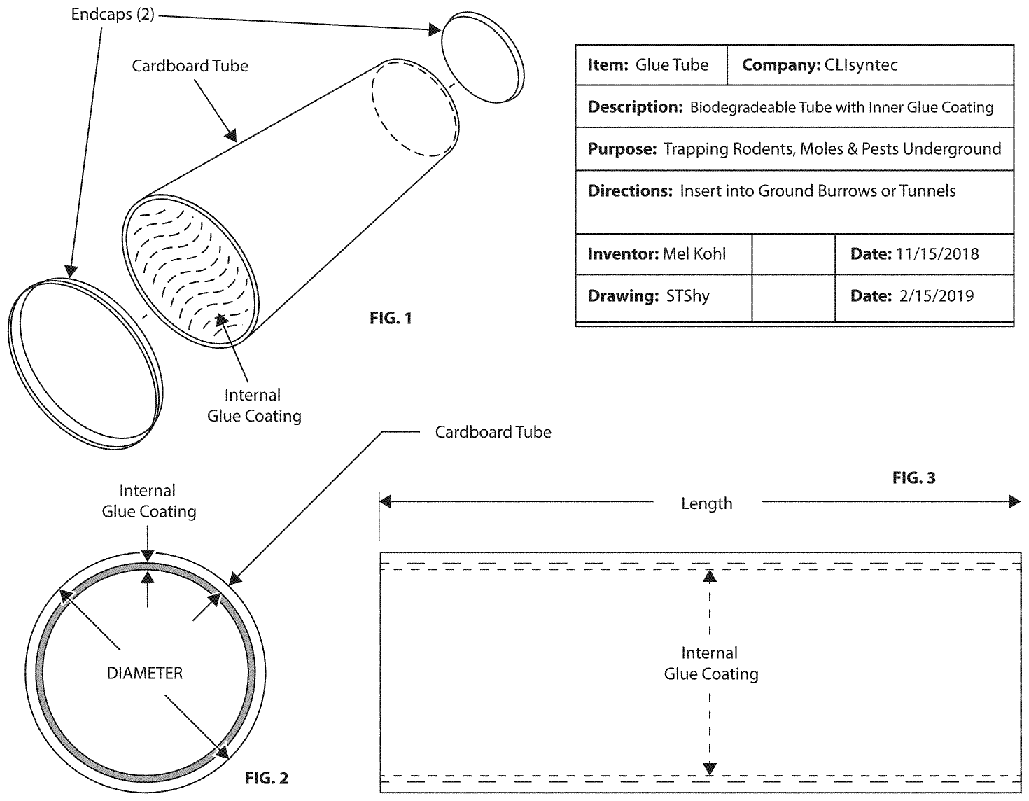

As shown in FIG. 1-3, a cardboard or like cylinder for forming a glue trap by coating the internal wall. Each tube is coated with a respective glue layer. The glue may be any type of non-drying biodegradable adhesive well-known in the art and may be baited or scented to attract particular rodents or insects.

When the endcaps are removed, the glue tube is ready for deployment in the ground where unwanted rodents are present.

The package again forms its own outer wrapper and printing or labeling may again be provided on its outer surfaces.

While only preferred embodiments of the invention have been described herein in detail, the invention is not limited thereby and modifications can be made within the scope of the attached claims.

I claim:

1. A glue trap package comprising a sturdy cardboard tube coated on the inside walls with a layer of non-drying biodegradable adhesive for trapping rodents, especially underground.
